(19) United States
(12) Patent Application Publication
(10) Pub. No.: US 2015/0046255 A1
(43) Pub. Date: Feb. 12, 2015

(54) Asset maps

(71) Applicants: John C. McAteer, San Carlos, CA (US); Emre Y. Baran, New York, NY (US); Yigal Dan Rubinstein, Mountain View, CA (US); Brett D. Goffin, New York, NY (US); Mackenzie C. Auster, New York, NY (US); Graham C. Cooke, London (GB); Biswapesh Chattopadhyay, Sunnyvale, CA (US)

(72) Inventors: John C. McAteer, San Carlos, CA (US); Emre Y. Baran, New York, NY (US); Yigal Dan Rubinstein, Mountain View, CA (US); Brett D. Goffin, New York, NY (US); Mackenzie C. Auster, New York, NY (US); Graham C. Cooke, London (GB); Biswapesh Chattopadhyay, Sunnyvale, CA (US)

(73) Assignee: GOOGLE INC., Mountain View, CA (US)

(21) Appl. No.: 12/058,489

(22) Filed: Mar. 28, 2008

(51) Int. Cl. G06Q 30/00; G06Q 30/02

(52) U.S. Cl. 705/14.49; 705/14.54

(57) ABSTRACT

Methods, systems and apparatus, including computer program products, for providing a graphical representation of advertiser assets and advertising parameters related to the assets. Marketable products and/or services can be represented graphically along with visual indications of the value of one or more advertising parameters related to an advertising campaign for those products and/or services. An implementation can provide selectable detailed advertising information, comparison to industry averages, and suggestions based on the comparison.

### BACKGROUND

The present disclosure relates to advertising.

All major mediums are used to deliver advertisements, including billboards, newspapers, magazines, radio, television, and the Internet. The advertisement industry is robust; generally including annual expenditures of hundreds of billions of dollars. Larger companies commonly employ full-time staff to develop, coordinate, and execute complex advertising and marketing strategies. Such strategies generally include advertising campaigns directed toward increasing revenue of the company through the promotion of one or more products and/or services offered by the company. Where the number of products and/or services offered is large, tracking advertising parameters such as budget expenditures, product coverage, and effectiveness can become difficult.

Modern advertising systems include features for providing advertisers with the ability to target advertisements to consumers more precisely than conventional techniques. Often these systems can directly measure the effectiveness of a given advertisement. For example, individual user responses, such as clicks on an Internet advertisement, can be recorded and stored for later reporting to the advertiser. These systems can record detailed data that can be very valuable to the advertisers in creating and managing advertising strategies. The volume and detail of the recorded data can be so great, however, that presenting it to advertisers in a meaningful format can prove challenging.

### SUMMARY

This specification describes technologies relating to graphically representing advertising efforts.

In general, one aspect of the subject matter described in this specification can be embodied in methods that include the actions of determining a value of a first advertising parameter for an advertiser asset, determining a value of a second advertising parameter for the asset, displaying a graphical representation of the asset, and displaying a graphical representation of the value of the first advertising parameter, and a graphical representation of the value of the second advertising parameter with the graphical representation of the asset. The graphical representation of the asset can be a displayed block that includes a description of the asset, and displayed blocks can be arranged in vertical categories. Values for the parameters can be displayed along with the blocks to which they correspond. The blocks can be shaded in proportion to a value of an advertising parameter. Advertising parameters can include a keyword coverage, a percentage of an advertising budget spent, a click through rate, a cost per click, an average advertisement position in a list for advertisements clicked, or an average advertisement position in a list for advertisements shown. Displayed blocks can include a bar graph having a length representing a value of one of the advertising parameters. A value of a keyword coverage parameter can be based on a percentage of a set of keywords generated by a keyword suggestion feature of an advertising system that are targeted by a group of advertisements mapped to the asset.

One aspect of the subject matter described in this specification can be embodied in methods that include the actions of collecting an asset map taxonomy, mapping an advertisement group to an asset of the taxonomy, determining an advertising parameter value for the asset, displaying an asset map based on at least a portion of the asset map taxonomy, the asset map including a graphical representation of the asset, and providing an asset reporting page upon the selection of the graphical representation of the asset, the reporting page including the determined value of the advertising parameter. Collecting an asset map taxonomy can include crawling a website located at a uniform resource locator associated with an advertiser identifier, crawling a domain of a uniform resource locator associated with an advertiser identifier, and/or reading a comma separated value file. Mapping an advertisement group to an asset of the taxonomy can include comparing advertisement group classifications of a set of advertisement groups to a name of the asset, identifying an advertisement group based on the comparison, and creating a mapping relationship between the identified advertisement group and the asset. An industry average parameter can be determined and displayed on a reporting page. One or more advertising parameters can be compared to the industry average and suggesting based on the comparison can be provided on a reporting page.

Particular embodiments of the subject matter described in this specification can be implemented to realize one or more of the following advantages. Asset maps created according to the described methods provide a graphical view of a multitude of advertising parameters in a detail-rich, yet easily understood format.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment of an advertising system including an asset map generator.

FIG. 2 shows an example asset map.

FIG. 3 is an example method for generating an asset map.

FIG. 4A is an example user interface screen of an asset map generator.

FIG. 4B is an example user interface screen of an asset map generator for creating a new asset map.

FIG. 5 is an example user interface screen for entering a taxonomy of an asset map.

FIG. 6A is an example user interface screen for assigning mapping relationships between an advertiser's advertisements stored in the data store and assets of an asset map taxonomy.

FIG. 6B is an example of an alternative user interface screen for associating an advertiser's advertisements stored in the data store with an asset map taxonomy.

FIG. 7 is an example user interface screen for selecting asset map details.

FIG. 8 lists a number of example record formats.

FIG. 9 is an example interactive asset map.

FIG. 10 is an example detailed report page.

FIG. 11 is an example method for providing an interactive asset map.

FIG. 12 is an example method for providing an advertising suggestion based on a comparison of an advertising parameter value with a corresponding industry average.

FIG. 13 is an example interactive asset map.

Like reference numbers and designations in the various drawings indicate like elements.

### DETAILED DESCRIPTION

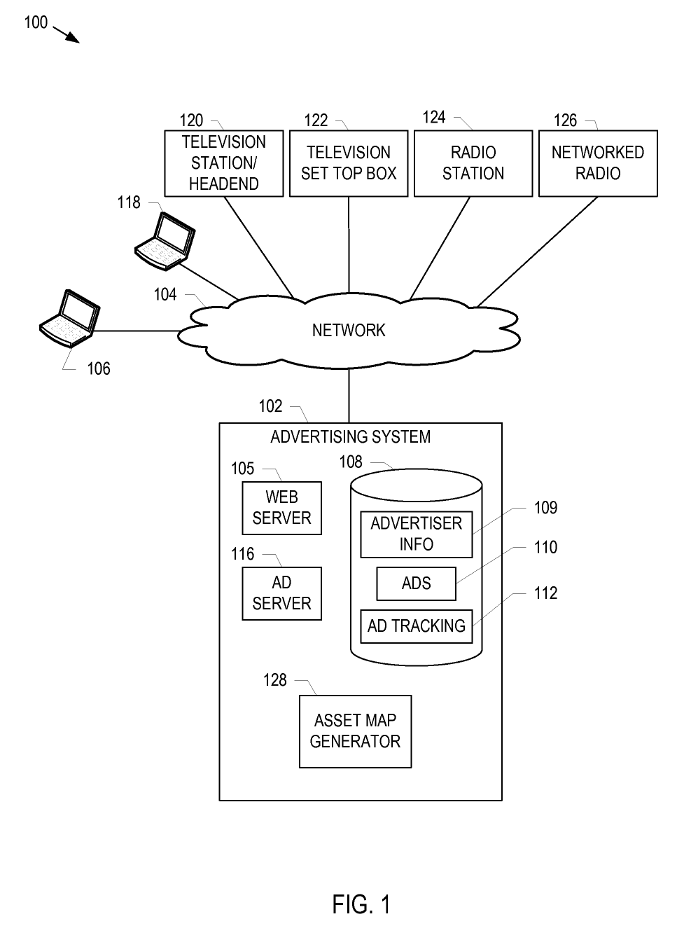

FIG. 1 is a block diagram of an example environment 100 of an advertising system 102 including an asset map generator 128. The advertising system 102 can communicate over the network 104 with the advertiser computer 106. The web server 105 serves computer code, such as hypertext markup language code to a web browser of the computer 106. The web browser of the computer 106 interprets the computer code to generate an advertiser interface on the computer 106. A user of the computer 106 can provide an account identifier, such as a username, as well as a password to log into the advertising system 102.

The advertising system 102 includes a data store 108 for storing advertiser information 109, advertisements 110, and advertisement tracking information 112. An advertisement server 116 can selectively retrieve an advertisement from the data store 108 and deliver the advertisement to, for example, the computer 118, the television station/headend 120, the television set top box 122, the radio station 124, and/or the networked radio 126. The advertising server 116 can select advertisements 110 from the data store 108 based on information provided by an advertiser and stored with the advertisement in the data store 108, such as the circumstances under which the advertiser wishes a given advertisement to be delivered, and a price, a bid, for example, that the advertiser is willing to pay to have the advertisement delivered.

An advertiser using the computer 106 can upload one or more advertisements to the advertising system 102 for storage in the data store 108. Uploaded advertisements can be associated in the data store 108 with an advertiser account identifier. An advertiser can group advertisements to create an advertisement group. Advertisement groups can include a set of logically related advertisements. For example, each of the advertisements in an advertisement group can advertise the same product or similar products, and/or share one or more targeted keywords. An advertising campaign can include one or more advertisement groups.

The advertisement server 116 can use information provided by the advertiser in selecting how and when the advertisement will be delivered. Where two or more advertisements submitted by different advertisers meet a given set of delivery criteria, the advertisement system can select and deliver the advertisement having a highest indicated bid amount, charging the corresponding advertiser for its delivery.

The information stored with an advertisement in the data store 108 utilized by the advertisement server 116 to select an advertisement for delivery can differ depending on the intended medium of delivery. For example, an advertisement to be delivered over the Internet to the computer 118 can be stored with one or more keywords that the advertiser designates for the advertisement and/or a geographic region for delivery of the advertisement. The advertising system 102 can be partnered with, for example, a search engine. If a user of the computer 118 enters a search query into the search engine that includes the designated keyword, the advertisement can be delivered to the user of the computer 118 along with a list of search results. The advertising system 102 can also be partnered with one or more websites. In such a case, the advertisement server 116 can deliver an advertisement to a designated advertisement area (for example, a right margin) of a partnered web site where the advertisement selected for display has a designated keyword that is related to the content of the website.

Information used by the advertisement server 116 for selecting television and/or radio advertisements for delivery can include, for example, a time of day, a specific show during which the advertisement should be aired, a genre of show during which the advertisement should be aired, a geographic region, and/or characteristics of a target demographic. The advertisement server 116 can select an advertisement for delivery to the television station/headend 120 and the radio station 124 for broadcast to a general audience. In an embodiment, more targeted advertisements can, for example, be delivered to the television set top box 122 and the networked radio 126, based on, for example, television watching and radio listening habits users of these devices. For example, the set top box 122, and/or the networked radio 126 can provide a user watching/listening log to the advertisement server 116 for comparison with advertisements and related information of the data store 108 for selecting an advertisement for delivery.

Advertisement tracking information can be stored in the data store 108. For example, a record of each advertisement delivery can be stored in the data store. The result of the delivery can be recorded as well. For example, in the case of an Internet delivered advertisement, an indication as to whether the delivery of the advertisement resulted in a user click can be recorded.

The asset map generator 128 can use advertisement tracking information from the data store 108 in generating an asset map (described below). In an implementation, the asset map generator 128 provides a user interface for collecting additional input for generation of an asset map. A user, for example, an employee of a company that operates the advertising system 102, and/or an employee of the advertiser can interact with the user interface of the asset map generator 128 to create an asset map. In some implementations, one or more asset map generation steps are automated. In some implementations all steps of asset map generation are automated.

In an implementation, advertisement groups stored in the data store 108 of the advertising system 102 are classified according to a set of standard classes. For example, each advertisement group of the advertising system can be assigned a class selected from the set of standard classes. This classification permits similar advertisements to be compared to determine, for example, relative delivery and performance characteristics of the advertisements. For example, the click through rate of an Internet advertisement can be compared to the average click through rate of other Internet advertisements belonging to the same class. Advertisements can be classified automatically, for example, by searching the content of the advertisement or by crawling a webpage at a destination URL of the advertisement and comparing the results to the standard classes to determine a best match. Alternatively, an advertiser can designate a category for an uploaded advertisement at or after the time of upload.

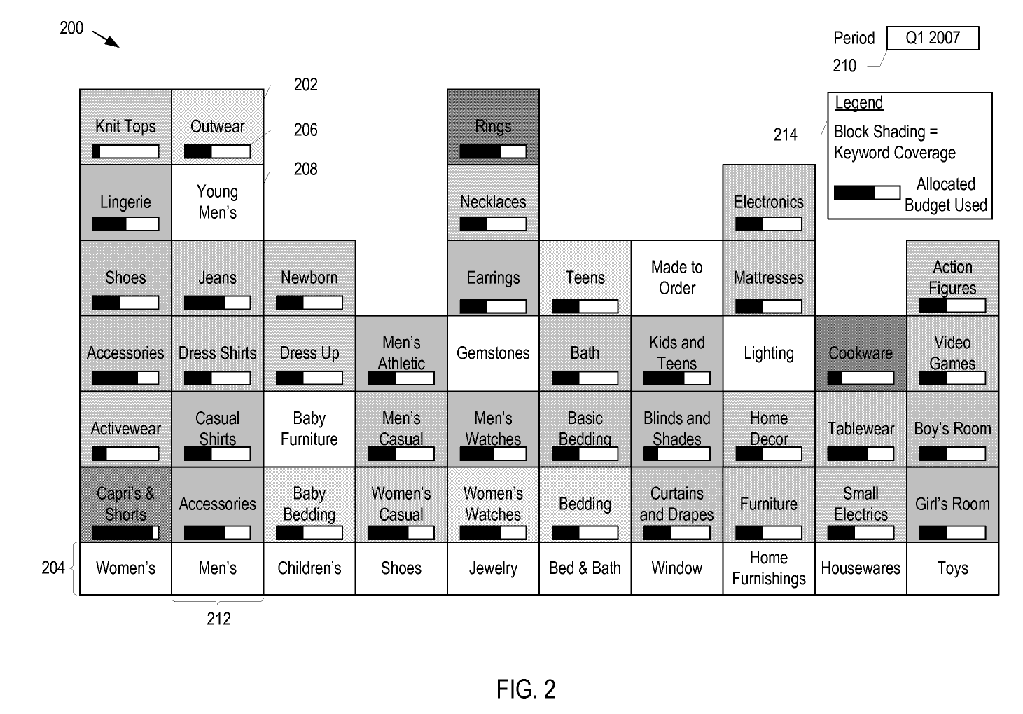

FIG. 2 shows an example asset map 200. An advertiser asset is any marketable product or service offered by the advertiser. The asset map 200 includes graphical representations of a plurality of advertiser assets. The asset blocks are arranged in vertical columns according to asset categories listed in the bottom row 204. Graphical blocks such as asset block 202 represent sub categories of advertiser products. Services and brands can be represented as well depending on whether the advertiser has such assets. The asset blocks include a description of the asset represented. For example, graphical block 202 represents products offered by the advertiser in the area of men's outwear. The asset map 200 also includes graphical representations of the values of multiple advertising parameters. An advertising parameter for an advertiser asset is any measurement related to advertisements promoting the asset.

The shading of a respective asset block of the example asset map 200 indicates a value of a first advertising parameter for the listed asset. The bar graph of each asset block indicates a value of a second advertising parameter for the listed asset. For instance, the shading of the asset block 202 can indicate the value of an advertising keyword coverage for advertisements promoting men's outwear products, and the respective bar graphs, such as bar graph 206, can indicate the value of an advertising budget parameter such as a percentage of an allocated budget that has been spent. Asset blocks, such as asset block 208, that have no indicated advertising parameter values represent assets that are not currently being advertised. Reporting period indicator 210 indicates the period of time corresponding to the information presented in the asset map 200. The legend 214 includes a description of the advertising parameter values that are represented graphically on the asset map 200. The asset map 200 can be generated automatically, for example, by the asset map generator 128 of the advertising system 102.

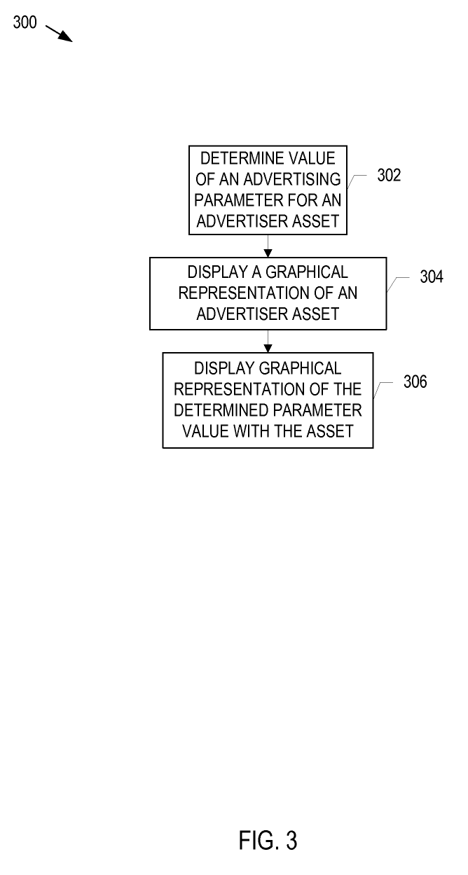

FIG. 3 is an example method 300 for generating an asset map. A value of an advertising parameter for an advertiser asset is determined (302). For example, a keyword coverage value, or an advertising budget parameter, for the asset can be determined. A graphical representation of an advertiser asset is displayed (304). The graphical representation can be, for example, an asset block that includes a name or description of the asset or a group of assets. For instance, for a retail advertiser a graphical representation of an asset can be a block representing a group of products such men's clothing, or a block representing a subset of men's clothing products such as outerwear. For example, the representation of an asset can be the asset block 202 of FIG. 2. A graphical representation of the determined parameter value is displayed with the representation of the asset (306). The graphical representation of the parameter value can include, for example, a visual characteristic of an asset block. For instance, in some implementations, a color and/or shading of an asset block represents the determined parameter value. For example, the shading of the block 202 of FIG. 2 can represent the determined parameter value. In some implementations, the length of a bar graph displayed in association with an asset block can be based on the determined parameter value. For example, the bar graph 206 of FIG. 2 can represent the determined parameter value. In some implementations, multiple advertising parameter values can be displayed graphically for a given asset. For example, an asset block can have a color and/or shading selected based on the value of one advertising parameter, and the length of a bar graph of the asset block can be based on a second parameter value. A representation of the value of any number of advertising parameters can be displayed with an asset block. A plurality of asset blocks with respective parameter values can be displayed together to form an asset map.

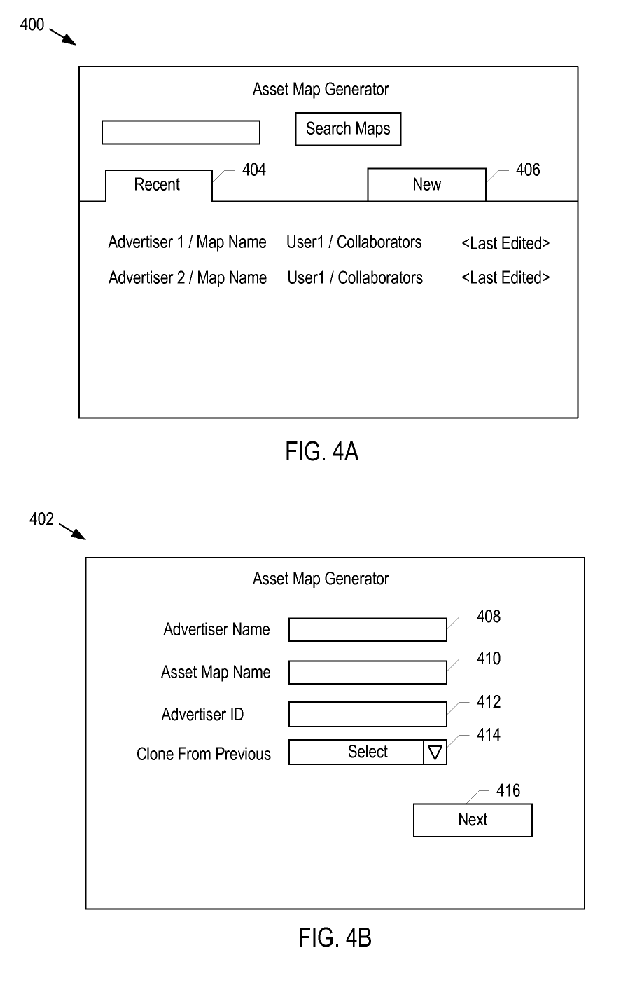

FIG. 4A is an example user interface screen 400 of an asset map generator 128. The user interface permits a user to search for previously created asset maps for editing. Recently edited asset maps are shown user the “recent” tab 404 and can be selected for editing. Selecting the “new” tab 406 can begin a process of creating a new asset map.

FIG. 4B is an example user interface screen 402 of an asset map generator for creating a new asset map. For example, the user interface screen 402 can be presented in response to a selection of the “new” tab 406. The name of the advertiser to which the asset map corresponds can be entered in the field 408 as well as a name for the asset map in field 410. An advertiser ID field 412 accepts an advertiser identifier. The advertiser identifier can be used, for example, to associate advertisements and related data with a given advertiser and to retrieve the same from the data store 108. A “clone from previous” drop down selection box 414 is populated with previously generated asset maps associated with the entered advertiser ID. Selection of a previously created asset map permits the use of the previously created map as a baseline for creating a new asset map. Selection of the “next” button 416 causes the user interface to proceed to the next step.

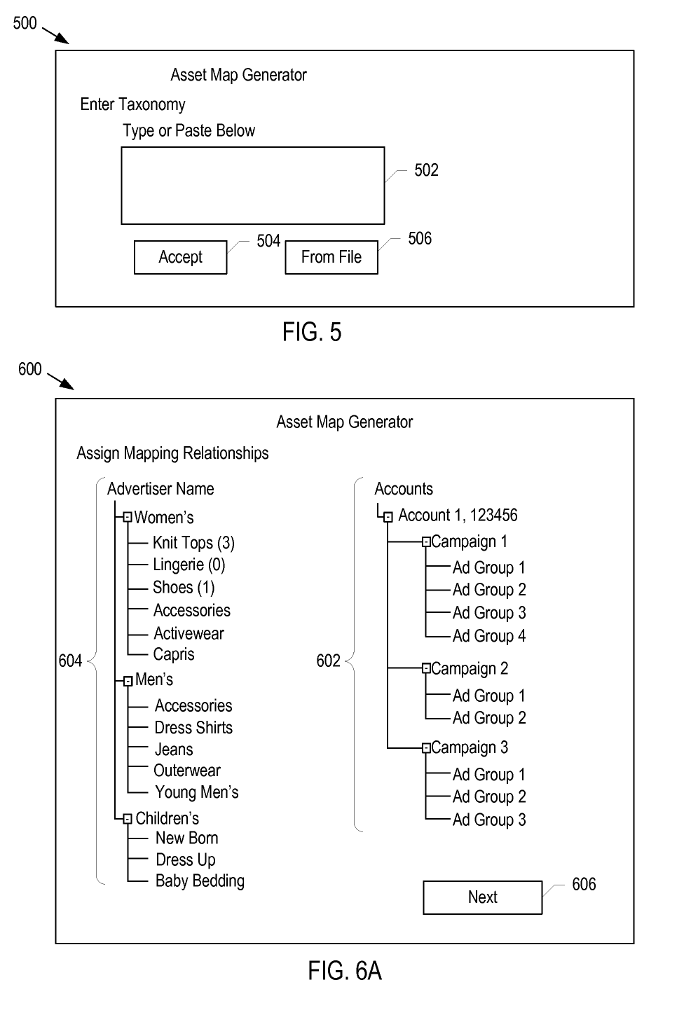

FIG. 5 is an example user interface screen 500 for entering a taxonomy of an asset map. The user interface screen 502 can be presented, for example, in response to a selection of the “next” button 416. The taxonomy can include categories and assets of a given advertiser, for example, a category such as “Men's” can include the assets “Accessories”, “Casual Shirts”, “Dress Shirts”, “Jeans”, “Young Men's”, and “Outerwear” as represented by column 212 of FIG. 2. The taxonomy can be entered in a comma separated value format in the text field 502. For example, a row of the comma separated data can include a category name followed by a list of the assets in the category, all separated by commas. Selecting the accept button 504 accepts the data entered into the text field 502. The data can alternatively be imported from a stored file by selecting the “from file” button 506.

In an implementation, the asset map generator 128 automatically creates a taxonomy. Using the advertiser ID entered on the user interface screen 402, the asset map generator 128 can search the data store 108 for advertisements corresponding to the advertiser ID and any associated URLs. For example, an advertisement associated with the entered advertiser ID can have a related URL where advertisement clicks are to be directed. The asset map generator 128 can direct a crawler (e.g., a web robot or other program configured to search web pages and follow included links) to visit the associated URLs to search for advertiser assets offered by the advertiser and/or described on the corresponding website. In an implementation, a complete domain of the associated URLs is crawled. Advertiser assets found can be collected for use in generating an asset map taxonomy. The collected assets can be compared to, classified, and named according to a standard taxonomy based on a best match. The standard taxonomy can include standard category and asset names that include related product and service types to which the collected information can be compared. For example, an asset named “tools” in the category “hardware” can include related keywords such as “hammer”, “saw”, and “screwdriver”. If a potential asset is located on an advertiser web page (found by crawling a URL and/or a domain of a URL) that includes the word “hammer”, the category “hardware” with an asset named “tools” is added to the taxonomy.

The standard taxonomy can, but does not necessarily, correspond to the standard set of classes for classifying advertisement groups described above. Standard classes are used to classify advertisement groups, while a standard taxonomy is used to create the categories and listed assets of an asset map.

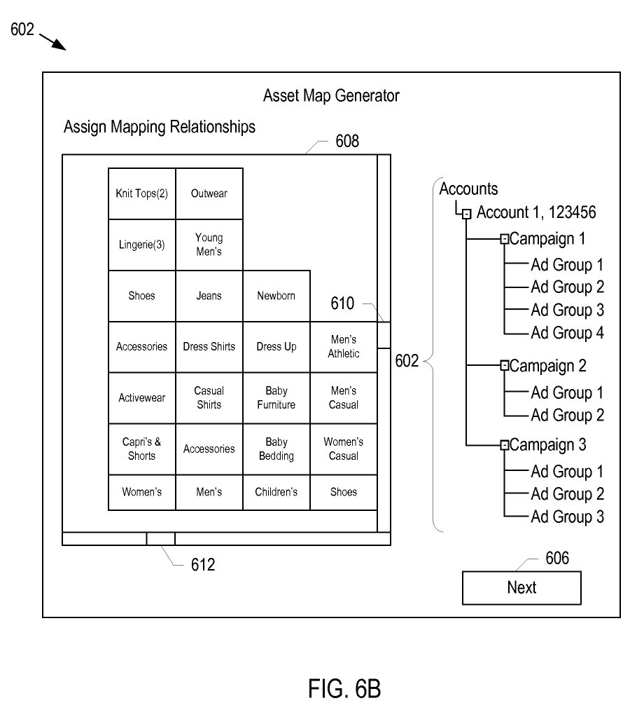

FIG. 6A is an example user interface screen 600 for assigning mapping relationships between an advertiser's advertisements stored in the data store 108 and assets of an asset map taxonomy. The expanded tree graph 602 includes a list of advertiser accounts corresponding to the advertiser ID entered on the screen 402. Each account includes one or more advertising campaigns that have associated advertisement groups. The expanded tree graph 604 lists the taxonomy for the asset map being created. Listed asset names are followed by the number of advertisement groups that are currently mapped to a given asset. By clicking and dragging a campaign and/or advertisement group onto an asset, a user can map an advertisement group to an asset. Mapping relationships can be removed, for example, by right clicking on the asset and selecting a “clear” option for a list of selectable options. Additional categories and assets can be created by, for example, right clicking in the tree graph 604 and selecting an add option from a menu. Choosing the next button 606 can cause the interface to proceed to the next asset map creation step.

FIG. 6B is an example of another user interface screen 602 for associating an advertiser's advertisements stored in the data store 108 with an asset map taxonomy. In FIG. 6B the taxonomy is displayed in a graphical format similar to the display format of an asset map in the display area 608. Scrollbars 610 and 612 permit a user to scroll across the graphically displayed taxonomy. Campaigns and/or advertisement groups can be clicked and dragged onto an asset block to create a mapping relationship between advertisement groups and the assets in the taxonomy.

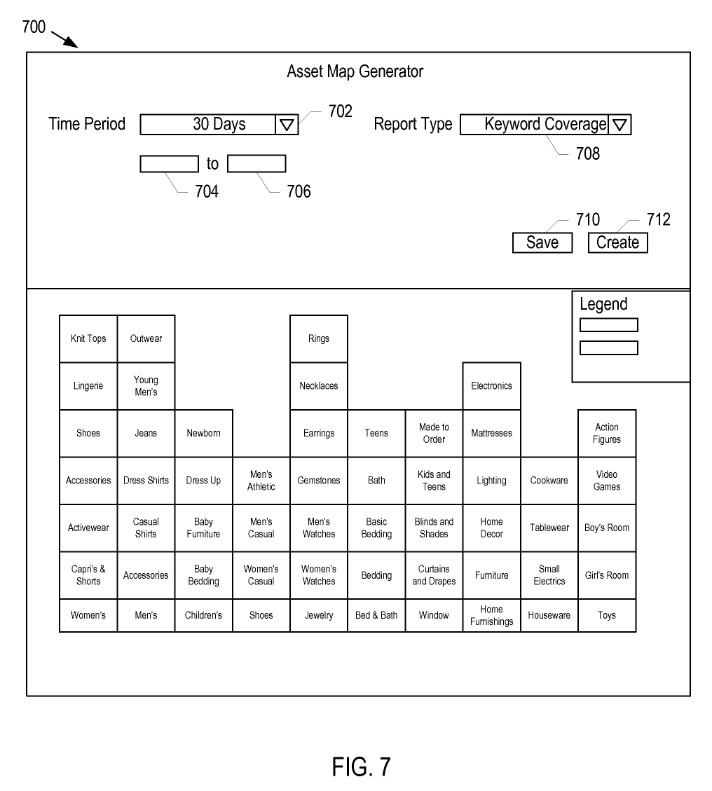

FIG. 7 is an example user interface screen 700 for selecting asset map details. A user can select a reporting period to be used in generating the asset map by choosing a selection from a dropdown menu 702 or entering a start and end date in fields 704 and 706 respectively. A report type can be selected from the dropdown menu 708, such as keyword coverage or click through rate report type. The map format can be saved by clicking the “save” button 710, this can, for example, save the current state of the asset map for later editing and completion. The asset map can be generated by clicking the “create” button 712. Upon clicking the “create” button, the asset map can be stored in the advertising system 102 and made accessible to its corresponding advertiser, for example, when the advertiser logs into the advertisement system 102.

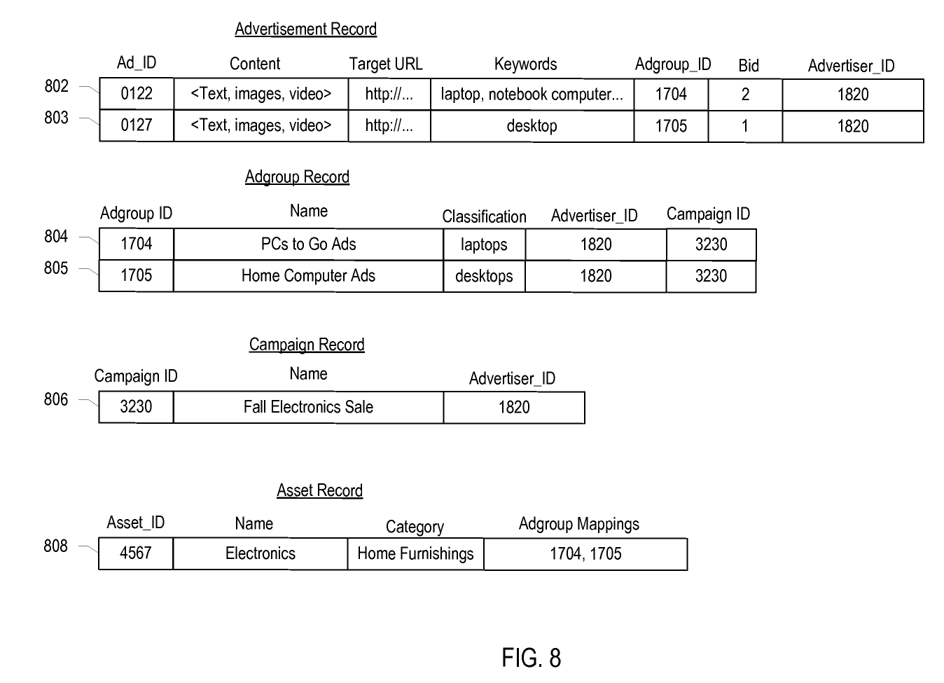

FIG. 8 lists a number of example record formats. Records 802 and 803 are example advertisement records. The records 802 and 803 include an advertisement identifier, advertising content, a target URL, one or more keywords, an advertisement group identifier, a bid amount, and an advertiser identifier. Records 804 and 805 are example advertisement group records. Records 804 and 805 include an advertisement group identifier, a name, an assigned classification, an advertiser identifier, and a campaign identifier. Record 806 is an example campaign record. The record 806 includes a campaign identifier, a name, and an advertiser identifier. Record 808 is an example asset record. The record 808 includes an asset identifier, a name, a category, and advertisement group mappings.

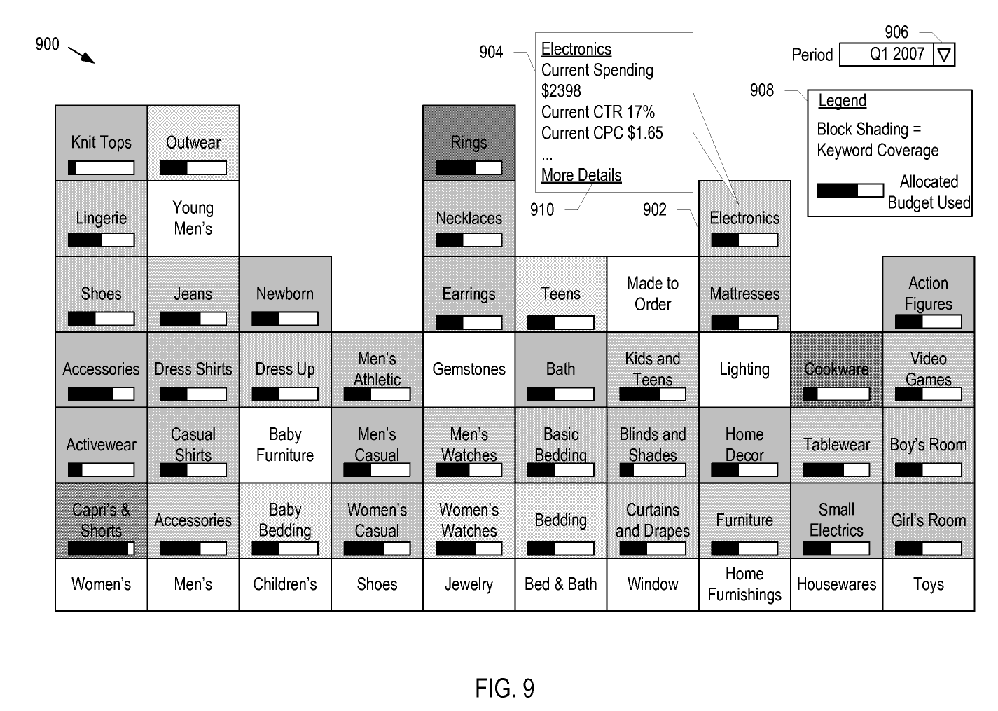

FIG. 9 is an example interactive asset map 900. The asset map 900 is structured similarly to the asset map 200 of FIG. 2. The asset map 900, however, is interactive. A user can select an asset block to receive additional information regarding the selected asset and advertisement parameters of advertisement groups mapped to the asset. For example, selecting the “electronics” asset block 902 can cause the information bubble 904 to appear which includes additional information regarding the asset block and advertisement parameters of advertisement groups mapped to the electronics asset block 902.

In an implementation, the reporting period for the interactive asset map 900 can be selected using the drop down selection box 906. In some implementations, selecting the legend 908 can permit a user to change the format of the interactive asset map 900. For example, a different advertising parameter can be selected for representation by the shading of the asset blocks, a different advertising parameter can be selected for representation by the bar graph of the asset blocks, and/or additional bar graphs can be added.

In an implementation, asset blocks are shaded according to a keyword coverage parameter. The value of a keyword coverage parameter can be determined, for example, based on a number of keywords targeted by advertiser for delivery of an advertisement relative to a set of suggested keywords generated by the advertising system. For instance, an advertisement system can include a keyword suggestion feature that provides a plurality of keywords related to a given topic, product, service, and/or asset. The keyword suggestions can be based on, for example, the subject and/or content of an advertisement, the content of a webpage related to the advertisement, and/or keywords targeted by other advertisers for similar topics, products, services, and/or brands.

In an implementation, keyword suggestions for a given asset are based on the classification of advertisement groups that are mapped to that asset. For example, the asset record 808 of FIG. 8 shows that the asset “electronics” has two advertisement groups mapped to it, 1704, and 1705. The advertisement group records 804 and 805 show that advertisement group 1704 has a classification of “laptops” and advertisement group 1705 has a classification of “desktops”. Keyword suggestions for the asset “electronics” can be based, for example, on query logs of a partnered search engine, on the results of crawling URLs associated with these assets, and/or on keywords targeted by other advertisement groups being classified as “laptops” and/or “desktops”.

The value of a keyword coverage parameter can be a percentage of the keywords suggested by the advertisement system for a given asset that are currently being targeted by the advertiser. For example, if 12 keywords are suggested by the advertising system for the asset “electronics”, and 6 of these keywords are currently targeted by the advertiser, the value of a keyword coverage parameter for the asset can be 50%. Keyword coverage of 50% for the asset “electronics” can be represented by a half-shaded asset block. Darker shadings can represent a higher keywords coverage value, while lighter shadings represent a lower value.

Alternatively, the value of a keyword coverage parameter can be based on a comparison of the number of impressions advertisements for a given asset current receive with an estimate of the number of impressions that would result if keyword coverage were extended to words suggested by the advertisement system.

In an implementation, the bar graph of a given asset represents a percentage of a budget allocated to advertising the asset that has been spent. For example, a maximum budget for an advertisement group can be designated by an advertiser and stored in the advertisement system. As advertisements from the advertising group are delivered, the advertiser is charged and the asset's allocated budget is decreased by the appropriate amount. When the allocated budget is completely spent, the advertising system can, for example, stop delivering the advertisements. The bar graph provides a visual representation of the percentage of the allocated budget that has been spent. If more than one advertisement group is mapped to an asset, such as in the example records of FIG. 8 where advertisement groups 1704 and 1705 are both mapped to the “electronics” asset block 902, the maximum budgets of the two advertisement groups and the amount of the allocated budget spent for the two advertisement groups can be combined in determining the percentage value to be graphically represented by the bar graph. In an implementation, budget overspending and budget underspending can be highlighted to point out where budget shifting would be effective.

In an implementation, selecting a link of the information bubble 904 such as the “more details” link 910 causes a detailed report page for the selected asset block to be displayed.

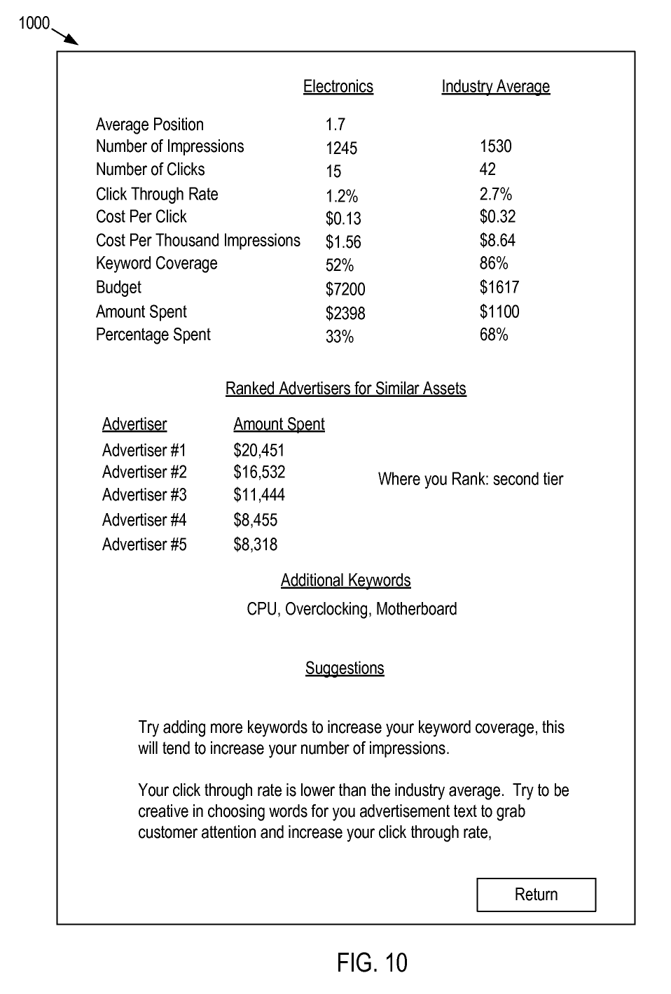

FIG. 10 is an example detailed report page 1000. The report page 1000 includes the value of a number of advertising parameters for the asset “electronics”. The report page also includes industry average values for these parameters as measured across the advertisement system 302 based on the classification of the advertisement groups mapped to the asset “electronics”. An additional keywords section lists keyword suggestions that are not currently targeted by the advertiser. A suggestions section is included that provides suggestions for an advertiser based on the relative performance of the advertising of the given asset versus the industry average.

Industry average values can be based on advertisement parameters of other advertisements having the same classification as the advertisement group or groups mapped to the selected asset block. Where advertisement groups having different classifications are mapped to a given asset block, the industry average values from each of the classifications represented can be weighted in proportion to the number of advertisements in the advertisement group with the corresponding classification. For example, the industry average values shown for the “electronics” asset can be composite industry average values. Two advertisement groups are mapped to the asset block “electronics” 902 of FIG. 9 as shown in the asset record 808 of FIG. 8. One of these advertisement groups “PCs to Go Ads” (Adgroup ID 1704) has a classification of “laptops”, and the other “Home Computer Ads” (Adgroup ID 1705) has a classification of “desktops”. The advertisement group “PCs to Go Ads” can include, for example, 9 advertisements and the advertisement group “Home Computer Ads” can include 1 advertisement. In this case, industry average values can be collected for both the “laptops” and the “desktops” classification, but the collected values for “laptops” can be given a weight of 90% and the collected values for “desktops” can be given a weight of 10% in combining the two collected values to create the composite industry average for the asset block “electronics”. Other weighting schemes for combining industry average values across classifications can also be used.

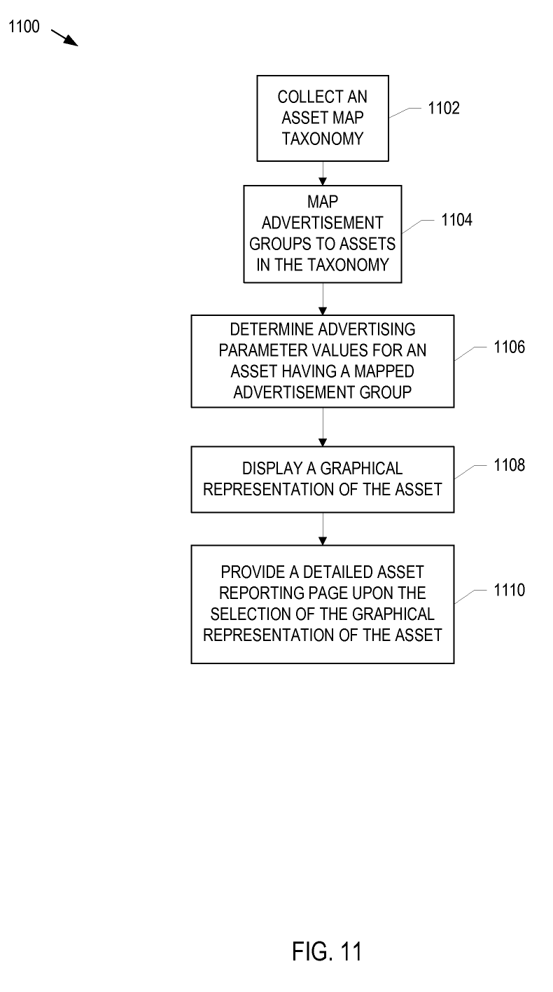

FIG. 11 is an example method 1100 for providing an interactive asset map. An asset map taxonomy is collected (1102). The taxonomy can be collected from a text input box, from a file, or collected by an automated process that crawls one or more associated URLs as described above. The taxonomy can include, for example, a list of categories and assets. Advertisement groups are mapped to assets in the taxonomy (1104). Advertisement groups can be mapped to assets, for example, using an interface screen such as interface screen 600 or 602. Alternatively, advertisement groups can automatically be mapped to assets in the taxonomy based on, for example, a comparison of advertisement group classifications with asset descriptions. Advertising parameter values are determined for an asset having a mapped advertisement group (1106). Advertisement parameters can include, for example, an average display position, a number of impressions, a number of clicks, a click through rate, a cost per click, a cost per thousand impressions, a keyword coverage, a maximum budget, an amount spent, and/or a percentage spent. A graphical representation of the asset is displayed (1108). For example, the asset can be represented by an asset block. Upon the selection of the graphical representation of the asset a detailed reporting page corresponding to the asset is provided (1110). For example, upon a selecting an asset block or selecting a “more details” link of an information bubble, a detailed reporting page can be displayed for the selected asset.

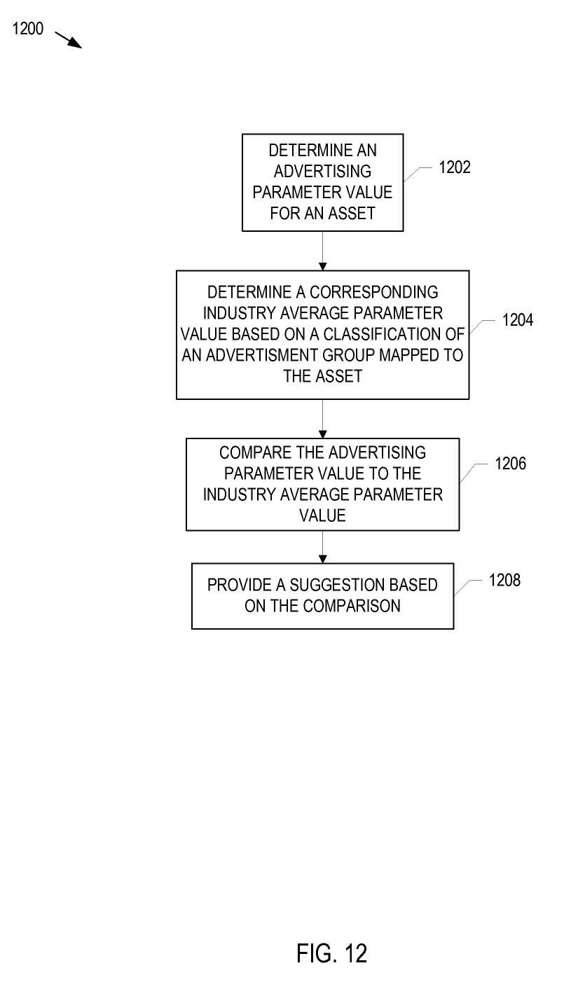

FIG. 12 is an example method 1200 for providing an advertising suggestion based on a comparison of an advertising parameter value with a corresponding industry average. An advertising parameter value is determined for an asset (1202). For example, a click through rate for a given asset can be determined. A corresponding industry average parameter value is determined that is based on a classification of an advertisement group mapped to the asset (1204). For example, an industry average click through rate for advertisement groups having the same classification as a classification of an advertisement group mapped to the asset can be determined. The advertising parameter value is compared the industry average value (1206), and a suggestion is provided based on the comparison (1208). For example, suggestions regarding techniques for improving a click through rate can be provided, such as better keyword targeting, different color creatives, etc.

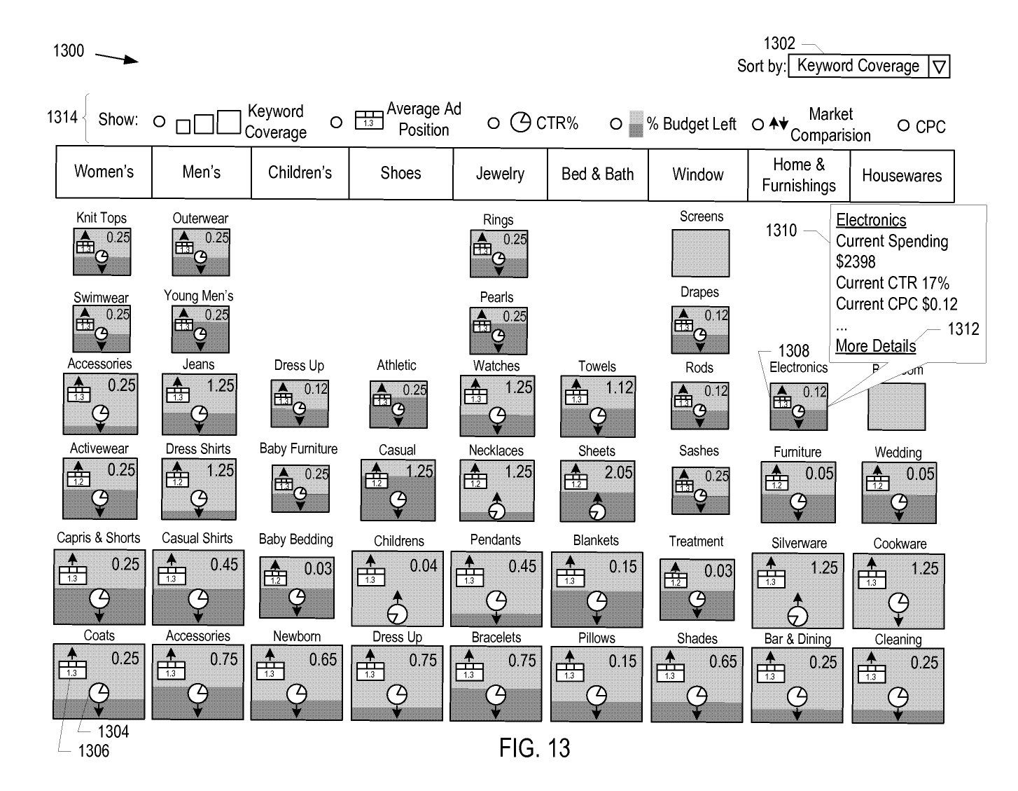

FIG. 13 is an example interactive asset map 1300. The asset map 1300 includes a dropdown selection box 1302 for selecting a sorting criteria. The asset map 1300 is shown with the asset blocks ordered top to bottom from those having the lowest keyword coverage to the greatest keyword coverage. The asset blocks of the asset map include a number of graphical representations of the values of respective advertising parameters. For example, the size of an asset block can be based on a keyword coverage value. The size of the asset block for women's coats is shown as being larger than the asset block for women's knit tops to represent, for example, that the advertising parameter of keyword coverage for women's coats is greater than the keyword coverage for women's knot tops. The shading an asset block can be based on a percentage of an allocated budget that is left unspent. For example, the shading of the asset block for athletic shoes can indicate that approximately three quarters of the advertising budget for this asset has been left unspent, while the shading of the asset block for children's shoes can indicate that the advertising budget for this asset has been completely spent. An icon, such as the pie chart icon 1304 can represent a click through rate advertising parameter. An arrow above the icon can indicate the value of the advertising parameter is higher than a market threshold based on a comparison of the value of the advertising parameter with the values for other companies for similar assets. An arrow below the icon can indicate the value of the advertising parameter is lower than a market threshold. An icon, such as web page icon 1306 can represent an average advertisement position advertisement parameter. For example, the icon can represent the average position that advertisements for the respective asset are placed in a list of advertisements. An arrow above the icon can indicate the value of the advertising parameter is higher than a market threshold. An arrow below the icon can indicate the value of the advertising parameter is lower than a market threshold. An actual computed value of the represented advertisement parameter can be included with the icon. The asset map 1300 can be interactive such that selecting an asset block, such as asset block 1308, causes additional information corresponding to the selected asset block. For example, clicking on, or mousing over asset block 1308 can cause the information bubble 1310 to appear. A link to an asset information page presenting more detailed information, such as link 1312 can be included. Selectable options such as the radio buttons in row 1314 can be used to enable and disable the display of the corresponding advertisement parameters. Checkboxes can also be used.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer implemented method, comprising:
identifying, by one or more processors, a category of products offered for sale by a given advertiser;
obtaining, for the category of products and by one or more processors, a set of suggested keywords for advertising the category of products based on information obtained from a web page that includes information about the category of products;
identifying, from advertising campaigns of the given advertiser, a set of advertisements that advertise the category of products and associated keywords used to distribute the set of advertisements;
determining, by one or more processors, a value of a first advertising parameter for the category of products, the value determination comprising determining a keyword coverage for the category of products based on a portion of the set of suggested keywords that match the associated keywords;
determining, by one or more processors, a value of a second advertising parameter for the category of products;
generating, by one or more processors, an asset map based on the category of products, the keyword coverage, and the value of the second advertising parameter; and
generating and outputting display data that display, at a device, a graphical representation of an asset map including at least the category of products and the keyword coverage for the category of products.

2. The method of claim 1, wherein:
the display data display a block that includes a description of one or more products included in the category of products.

3-4. (canceled)

5. The method of claim 1, wherein:
the display data that display a graphical representation of the asset map comprises display data that display a block that includes a description of the category of products; and
the display data that display the block in proportion to the value of the first advertising parameter.

6. The method of claim 5, wherein:
the second advertising parameter comprises a percentage of an advertising budget spent, a click through rate, a cost per click, an average advertisement position in a list for advertisements clicked, or an average advertisement position in a list for advertisements shown.

7. The method of claim 5, wherein:
the display data further display a bar graph having a length proportional to the value of the second advertising parameter.

8. The method of claim 7, wherein:
the second advertising parameter is a percentage of an advertising budget spent.

9. (canceled)

10. The method of claim 1, wherein:
the display data further display a bar graph having a length proportional to the value of the first advertising parameter.

11. (canceled)

12. The method of claim 1, wherein:
determining a value of a second advertising parameter for the category of products comprises retrieving the advertising tracking information from a data store of an advertising system.

13. The method of claim 12, wherein:
the advertising tracking information is retrieved from the data store based on a mapping relationship between the category of products and at least one advertisement group.

14. The method of claim 1, wherein:
the display data further display a third advertising parameter value upon selection of the graphical representation.

15. The method of claim 14, wherein:
selection of the graphical representation of the asset comprises one of: clicking on the graphical representation or moving a pointing indicator over the graphical representation.

16. The method of claim 1, wherein:
the display data further display a selectable link pointing to a product information page upon selection of the graphical representation.

17-25. (canceled)

26. The method of claim 1, further comprising providing display instructions to a computing device, the display instructions, when executed by the computing device, cause the computing device to display a user interface screen of an asset map generator on the display.

27. The method of claim 26, further comprising:
receiving user input, the user input being provided through an input interface of the user interface; and
searching for previously created asset maps for editing to provide the asset map based on the user input.

28. The method of claim 26, further comprising:
receiving user input, the user input being provided through the user interface; and
creating the asset map as a new asset map in response to receiving the user input.

29. The method of claim 28, wherein the user input comprises one or more of a name of the advertiser, a name of the asset map, and an advertiser identifier that associates advertisements and related data with the advertiser.

30-33. (canceled)

34. A non-transitory computer readable medium with computer program instructions encoded thereon that, when executed by data processing apparatus, cause the data processing apparatus to perform operations comprising:
identifying a category of products offered for sale by a given advertiser;
obtaining, for the category of products, a set of suggested keywords for advertising the category of products based on information obtained from a web page that includes information about the category of products;
identifying, from advertising campaigns of the given advertiser, a set of advertisements that advertise the category of products and associated keywords used to distribute the set of advertisements;
determining a value of a first advertising parameter for the category of products, the value determination comprising determining a keyword coverage for the category of products based on a portion of the set of suggested keywords that match the associated keywords;
determining a value of a second advertising parameter for the category of products;
generating an asset map based on the category of products, the keyword coverage, and the value of the second advertising parameter; and
generating and outputting display data that display, at a device, a graphical representation of an asset map including at least the category of products and the keyword coverage for the category of products.

35. A system, comprising:
a computer readable medium having computer program instructions encoded thereon; and
data processing apparatus that executes the computer program instructions that cause the data processing apparatus to perform operations comprising:
identifying a category of products offered for sale by a given advertiser;
obtaining, for the category of products, a set of suggested keywords for advertising the category of products based on information obtained from a web page that includes information about the category of products;
identifying, from advertising campaigns of the given advertiser, a set of advertisements that advertise the category of products and associated keywords used to distribute the set of advertisements;
determining a value of a first advertising parameter for the category of products, the value determination comprising determining a keyword coverage for the category of products based on a portion of the set of suggested keywords that match the associated keywords;
determining a value of a second advertising parameter for the category of products;
generating an asset map based on the category of products, the keyword coverage, and the value of the second advertising parameter; and
generating and outputting display data that display, at a device, a graphical representation of an asset map including at least the category of products and the keyword coverage for the category of products.
